(19) United States
(12) Patent Application Publication
(10) Pub. No.: US 2004/0221283 A1
(43) Pub. Date: Nov. 4, 2004

(54) Enhanced, modulo-scheduled-loop extensions

(76) Inventor: Christopher S. Worley, Fort Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/427,482

(22) Filed: Apr. 30, 2003

(51) Int. Cl. G06F 9/45

(52) U.S. Cl. 717/160; 717/150

(57) ABSTRACT

A method for employing architectural support for modulo-scheduled loop pipelining provided in modern processors in order to write more flexible, more efficient, and a greater variety of enhanced modulo-scheduled loops. A described embodiment of the present invention allows for arbitrary selection of any rotating predicate register to control the transition from kernel phase to epilog phase, and thereby enable multiple, parallel streams of execution within a software-pipelined loop.

### TECHNICAL FIELD

The present invention relates to software pipelining techniques and, in particular, to a flexible, multi-stream, software-pipelined loop employing architecture support for modulo scheduled loops in modern processors.

### BACKGROUND OF THE INVENTION

The current invention is described with reference to an embodiment implemented on a processor of the Intel® Itanium processor family employing architectural support for modulo-scheduled loops. The details of the Intel® Itanium architectural support are provided, along with the described embodiment of the present invention, in a following section. In this section, background describing motivations for counted-loop optimization is provided.

FIGS. 1A-C illustrate a simple assembler-language counted loop. In FIG. 1A, assembler code for a simple counted loop is provided. FIGS. 1B-C illustrates operation of the simple counted loop provided in FIG. 1A. As shown in FIG. 1B, the assembler-code loop operates on two arrays 102 and 103 each containing 32-bit integer values. In FIG. 1B, and in subsequent figures, integer values are represented by letters, such as the letters “a,” “b,” “c,” and “d” contained in the first four elements 104-107 of the first array 102. The assembler-code loop is designed to traverse the first array 102, extracting each 32-bit integer value from the array, adding an integer value “x” to the extracted value, and depositing the sum of the extracted value and the value “x” into the element of the second array 103 with the same index of the extracted value. As shown in FIG. 1B, the register “r30” 108 contains a pointer to the next element of array 102 to be extracted, and register “r31” 109 contains a pointer to the next element of array 103 into which a sum is to be deposited. At the beginning of loop execution, the registers “r30” and “r31” reference the first elements of arrays 102 and 103, respectively.

Register “r39” 110 contains the value “x” to be added to each element extracted from array 102. The special register “LC” 111 contains a loop counter that, in the current case, is the index of the last element in arrays 102 and 103 assuming the first elements of both arrays are indexed by integer value “0.” FIG. 1C illustrates the first iteration of the counted-loop assembler code provided in FIG. 1A. The value of the first element of array 102, “a,” is extracted from the first element of array 102 and placed into register “r34” 112. The value “x,” stored in register “r9” 110, is added to the extracted value “a” stored in register “r34” 112, and the sum is stored in register “r36” 113. The sum stored in register “r36” is then moved into the first element 114 of array 102. The pointers in registers “r30” and “r31” are incremented so that registers “r30” and “r31” point to the second elements of arrays 102 and 103, respectively, and the loop-count register “LC” is decremented. The assembler-code loop continues to iterate in this fashion until the value “x” has been added to all extracted values from all elements of array 102 and the resulting sums placed into the elements of array 103.

Operation of the assembler-code counted loop shown in FIG. 1A is easily described in view of the above discussion referencing FIGS. 1A-C. The symbol “L1:” 116 is a label to which the branch instruction 118 at the end of the counted loop may direct control flow to initiate another iteration of the loop. The mov instruction 120 prior to the first instruction of the loop loads the integer value “199” into the register “LC,” in order to prepare for 200 iterations of the loop in order to process arrays of length 200. During the first iteration of the counted loop, the first loop instruction, ld4 instruction 122, loads the contents of the first element of the first array (102 in FIG. 1B), a pointer to which is stored in register “r30,” into register “r34,” with post increment of register “r30” to leave register “r30” containing a reference to the next element of the first array to be extracted in a subsequent counted-loop iteration. The second instruction of the counted loop, add instruction 124, adds the contents of register “r9” to the contents of register “r34” and stores the sum into register “r36.” During the first iteration of the counted loop, the third instruction of the counted loop, st4 instruction 126, stores the contents of register “r36” into the first element of the second array (103 in FIG. 1B), pointed to by a reference contained in register “r31,” post-incrementing register “r31” so that the pointer contained in register “r31” references the next element of the second array into which a value should be stored, in a subsequent counted-loop iteration. Finally, the br.cloop instruction 118 checks if the contents of register “LC” are greater then zero. If so, the contents of register “LC” are decremented by one and the branch is taken, branching back to the first instruction 122 of the loop.

In the column 128 to the right of the instructions in FIG. 1A, an integer value is associated with each instruction to indicate the execution cycle in which the instruction is executed. The mov instruction 120 is executed prior to the beginning of the loop, and therefore executes during execution cycle −1. The ld4 instruction 122 executes in execution cycle 0. Because the ld4 instruction requires two execution cycles to complete, the next instruction 124 cannot execute until execution cycle 2. In the Intel® Itanium processor, a number of instructions may execute in parallel. However, because the add instruction 124 updates register “r36,” while the st4 instruction 126 uses the contents of register “r36,” the st4 instruction 126 must execute in an execution cycle subsequent to that in which the add instruction 124 executes. Thus, the st4 instruction 126 executes in execution cycle 3, along with the br.cloop instruction 118.

As can be seen from FIG. 1A, the assembler-code counted loop illustrated in FIG. 1A incurs a wasted execution cycle following the ld4 instruction 122 during each loop iteration. It would be desirable, particularly since the Itanium architecture allows parallel execution of instructions, to eliminate such wasted execution cycles. FIGS. 2A-C illustrate one approach to eliminating the wasted execution cycle in the assembler code shown in FIGS. 1A-C. As shown in FIG. 2A, two ld4 instructions 202 and 204 are carried out in execution cycles 0 and 1, respectively, in order to load values from adjacent cells in the first array (102 in FIG. 2B) into registers “r34” and “r35,” respectively. Next, two add instructions 206 and 208 add the contents of register “r39” to the contents of registers “r34” and “35,” respectively, and place the sums in registers “r36” and “r37.” Then, in st4 instructions 210 and 212, the contents of registers “r36” and “r37” are stored into adjacent cells of the second array (103 in FIG. 2B). Considering the instruction cycles listed in the column 214 to the right of the instructions in FIG. 2A, it can be seen that the wasted execution cycle observed in the assembler code shown in FIG. 1A has been eliminated. However, the cost of eliminating this execution cycle is an increased number of instructions in the loop, and increased complexity of register usage.

FIGS. 2B-C illustrate operation of the assemble-code loop shown in FIG. 2A. Initially, the contents of registers “r30” 108 and “r31” 109 point to the first elements 104 and 114 of the two arrays 102 and 103. In the first loop iteration, the contents of the first two elements 104 and 105 of the first array 102 are moved into registers “r34” 112 and “r35” 216. The contents of register “r39” 110 is added to the contents of registers “r34” and “r35,” and the sums stored in registers “r36” 113 and “r37” 217. The contents of registers “r36” and “r37” are then moved to the first two cells 114 and 218 of the second array 103, and the contents of registers “r30” 108 and “r31”. 109 are each twice incremented in post-increment instructions so that they point to the third cells 106 and 219 of the first and second arrays 102 and 103, respectively.

Although the wasted execution cycle has been eliminated in the assembler code shown in FIG. 2A, this assembler-code loop still does not take full advantage of the Itanium architecture's support for parallel instruction execution. The execution of the two load instructions 202 and 204, for example, are serialized, because both load instructions use the contents of register “r30” with post increment of register “r30.” Because of the mutual dependency on register “r30,” the two load instructions need to execute in different execution cycles. By employing additional registers and further increasing the number of instructions, greater parallelism is achievable. However, this process of unrolling loops and increasing the size and complexity of loops, particularly for larger loops, may lead to inefficient execution due to the inability of the processor to store all the instructions of the loop in highest-speed cache. The loop-unrolling technique also leads to complex assembler code that is not easily reused for similar, but different execution tasks. In other words, the resulting complex assembler code must be laboriously reviewed and altered to handle each different problem in a set of related problems. For these reasons, computer architects, designers, and manufacturers, as well as compiler developers and software engineers, have recognized the need for a more flexible approach to achieving execution-cycle efficiency and highly parallel instruction execution without incurring additional code complexity and instruction expansion within loops.

### SUMMARY OF THE INVENTION

One embodiment of the present invention is a method for employing architectural support for modulo-scheduled-loop pipelining provided in modern processors in order to write more flexible, more efficient, and a greater variety of enhanced modulo-scheduled loops. While predicate register “p16” is architecturally designated to control the transition from kernel to epilog phases of a software-pipelined loop, a described embodiment of the present invention relaxes that constraint to enable use of an arbitrarily selected rotating predicate register to control the transition from kernel phase to epilog phase and to thereby enable multiple, parallel streams of execution within a software-pipelined loop designed according to one embodiment of the present invention.

### BRIEF DESCRIPTION OF THE DRAWINGS

FIGS. 1A-C illustrate a simple assembler-language counted loop.

FIGS. 2A-C illustrate one approach to eliminating the wasted execution cycle in the assembler code illustrated in FIGS. 1A-C.

FIG. 3 illustrates architectural support in the Intel® Itanium processor for software pipelining of modulo-scheduled loops.

FIGS. 4A-F illustrates operation of a small example of rotating registers.

FIG. 5 is a flow-control diagram of the br.ctop instruction.

FIG. 6 shows the software-pipelined version of the assembler-code routine shown in FIG. 1A.

FIGS. 7A-7H illustrate operation of the software-pipelined version of the assembler-code loop, shown in FIG. 6.

FIG. 8 is a high-level illustration of the perceived values of predicate registers during execution of a software-pipelined loop.

FIG. 9 illustrates the kernel and epilog phases of software-pipelined loop execution under the described embodiment of the present invention using the illustration conventions of FIG. 8.

### DETAILED DESCRIPTION OF THE INVENTION

One embodiment of the present invention is a method for more flexibly encoding routines to use the software-pipelining-architectural support in modem processors, including the Intel® Itanium processor, for pipelining modulo-scheduled loops. In order to describe this embodiment of the present invention, the traditional modulo-scheduled-loop pipelining techniques contemplated by modern processor architects and promulgated by modem processor vendors is first described.

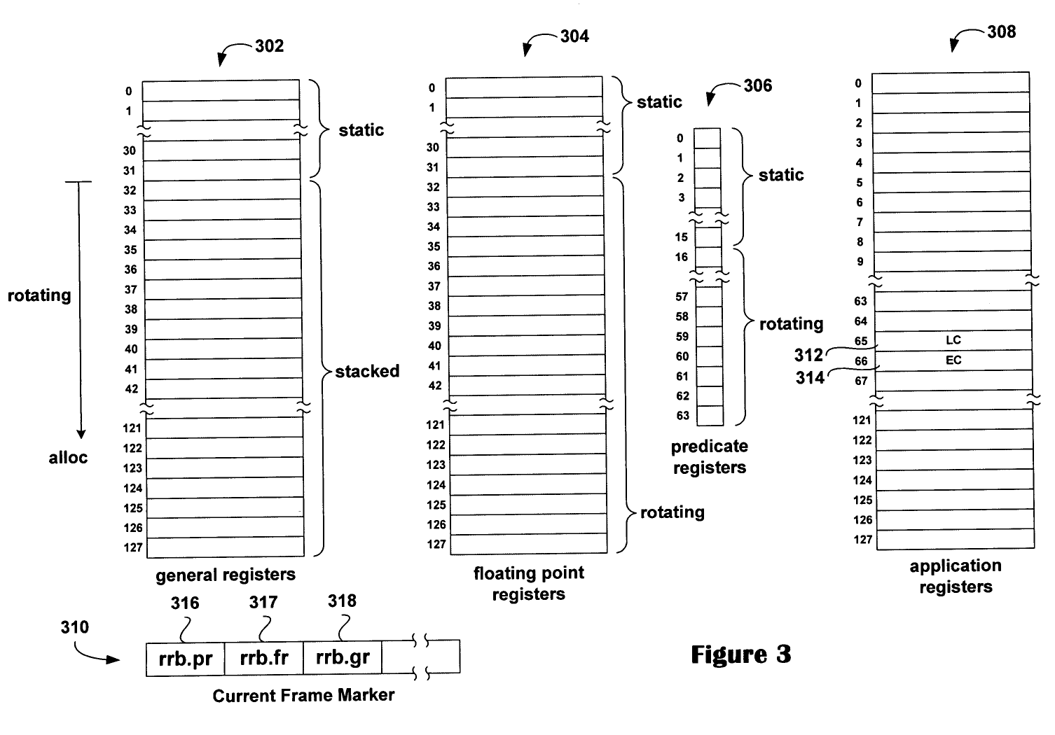

FIG. 3 illustrates architectural support in the Intel® Itanium processor for software pipelining of modulo-scheduled loops. The Itanium architecture includes 128 general registers 302, 128 floating-point registers 304, 64 predicate registers 306, 128 application registers 308, and a current-frame-marker register 310. The general registers 302, floating-point registers 304, and application registers 308 are 64-bit registers, while the predicate registers 306 are 1-bit registers. The predicate registers are associated with instructions, and contain Boolean values that determine whether or not the associated instructions are executed. Examples of the use of predicate registers follow. The sets of general registers, floating-point registers, and predicate registers each includes a subset of static registers and a subset of rotating registers. In the case of the general registers 302, the number of rotating registers can be dynamically specified using the instruction “alloc.” In the case of the general registers and floating-point registers, the first 32 registers are architecturally defined as static registers. In the case of the floating-point registers, all non-static registers compose a single set of rotating registers. In the case of the general registers, some number of registers, beginning with register “r32,” can be defined to be rotating, with the total number of rotating registers restricted to a multiple of 8. In the case of the predicate registers, the first 16 registers “p0”-“p15” are static, and the remaining 48 predicate registers are rotating. Software pipelining employs two application registers, register “LC” 312, described above, and register “EC” 314, to be described below. The current-frame-marker register 310 includes a rotating register-base field 316-318 for each of the predicate registers, floating-point registers, and general registers, respectively.

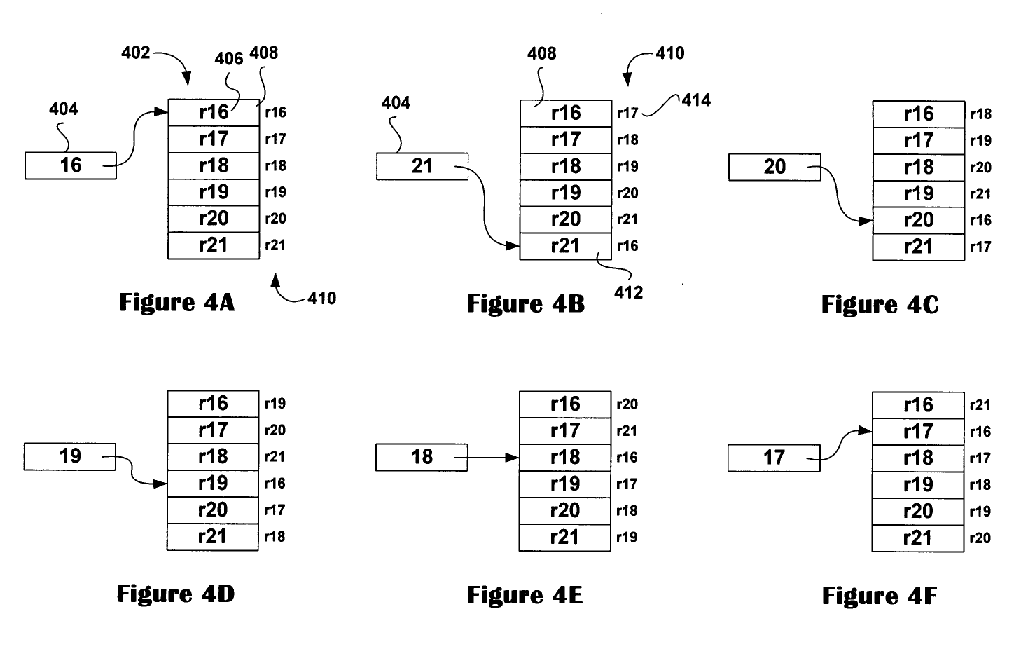

FIGS. 4A-F illustrates operation of a small example set of rotating registers. In FIGS. 4A-4F, a set of six rotating registers “r16”-“r21” is employed, although, in the Intel® Itanium architecture, a set of 6 rotating registers is not supported and registers “r16”-“r21” do not rotate. The artificial set of rotating registers is used, in this example, to illustrate certain phenomenon that would be difficult to succinctly illustrate using the actual, supported, rotating register set. In each figure of FIGS. 4A-F, such as in FIG. 4A, the six registers are shown in a column 402, along with the rotating register-base field 404 of a current-frame-marker register (310 in FIG. 3). In each of FIGS. 4A-4F, the registers are labeled with register numbers within the cells representing registers. For example, in FIG. 4A, register “r16” is labeled with a text “r16” 406 within the cell 408 representing register “r16.” These are the actual register designations for the registers. On the right-hand side of the cells, in a column 410, the perceived register designations for the registers are listed. In FIG. 4A, the perceived register designations identically match the register numbers contained within the cells. The rotating register-base field 404 contains the index of the current rotating-register base. Thus, in FIG. 4A, the rotating register-base field 404 indicates that register “r16” is the current rotating register base for the set of registers “r16”-“r21,” and therefore the perceived register designations identically match with the registers.

In a modulo-scheduled loop, the branch instruction at the bottom of the loop may automatically decrement the rotating register-base field prior to directing control back to the top of the loop. FIG. 4B illustrates the results of decrementing the rotating register-base field following the first iteration of a loop. In FIG. 4B, the rotating register-base field 404 now contains the value “21,” the modulo arithmetic value obtained by subtracting one from the value “16,” where 16 is the first integer in a the subgroup of integers “r16”-“r21.” Thus, the current rotating register base, following the decrement of the rotating register-base field, for example by a counted-loop branch instruction, is now register “r21” 410. Note that, at this point, the perceived register designations in column 410 no longer match the register numbers. Actual register “r21” 412 is now perceived to be register “r16.” Similarly, actual register “r16” 408 is now perceived to be register “r17” 414. A decrement of the rotating register-base field results in each register r(n) being perceived as register r(n+1). The rotating register architecture thus allows for automatic renaming of registers during each loop iteration, to eliminate the need for explicitly naming and using different registers within a loop in order to take advantage of the parallel execution features of a modem processor. FIGS. 4C-F illustrate the contents of the rotating register-base field, and the perceived register designations for each register, following successive decrements of the rotating register-base field. Note that a subsequent decrement of the rotating register-base field following the rotating-register state indicated in FIG. 4F would produce the rotating register state illustrated in FIG. 4A.

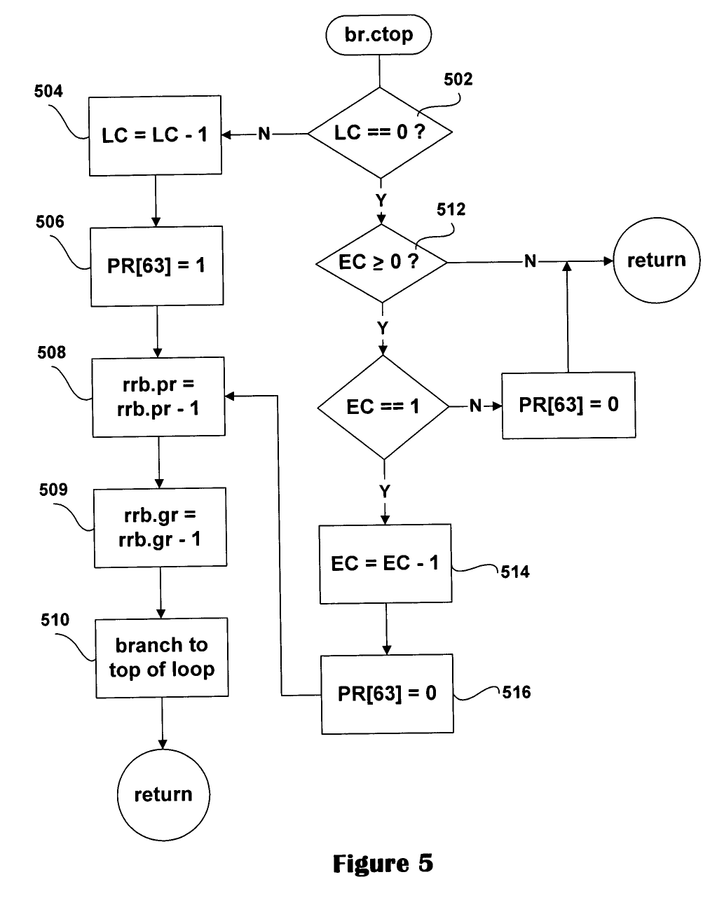

The architectural support for software pipelining of modulo-scheduled loops includes the br.ctop branch instruction. Other branch instructions that support modulo-scheduled loops include br.cexit, br.wtop, and br.wexit. All four branch instructions can be used in alternative embodiments of the present invention, but, in the following description, only the br.ctop branch instruction is employed in examples. The alternate embodiments employing the br.cexit, br.wtop, and br.wexit branch instructions are readily derived by one skilled in the art, and are not included in order to avoid redundant description. FIG. 5 is a flow-control diagram of the br.ctop instruction. In conditional step 502, the br.ctop instruction checks the loop-account register “LC” to see if the current value of register “LC” is zero. If the current value of register “LC” is not zero, then, in step 504, register “LC” is decremented. Next, step 506, predicate register “p63,” the last predicate register in the rotating predicate-register set, is set to the value “1,” or TRUE, so that, when the predicate rotating register-base field is next decremented, in step 508, the first rotating predicate register “p16” has the value “1,” or TRUE. In step 509, general-register rotating register-base field is decremented, to rotate the rotating general registers for the next iteration of the loop. Then, in step 510, control is directed to the label target of the br.ctop instruction. If the contents of the register “LC” is zero, as detected in step 502, then control flows to conditional step 512, where the br.ctop instruction determines whether the current contents of the epilog register “EC” is greater than one. If the contents of register “EC” is not greater than one, as detected in step 512, then the epilog phase of the software-pipeline loop has finished, and the br.ctop instruction returns, with control essentially falling through to the first instruction that follows the modulo-scheduled loop. However, if the contents of register “EC” are greater than one, then, in step 514, the br.ctop instruction decrements the epilog counter register “EC,” places the value. “0,” or FALSE, into predicate register “pr63” in step 516, and then control flows to previously described step 508, in which the predicate rotating register-base field is decremented, to step 509, in which the general rotating register-base field is decremented. Finally, the br.ctop instruction, in step 510, directs control back to the top of the loop.

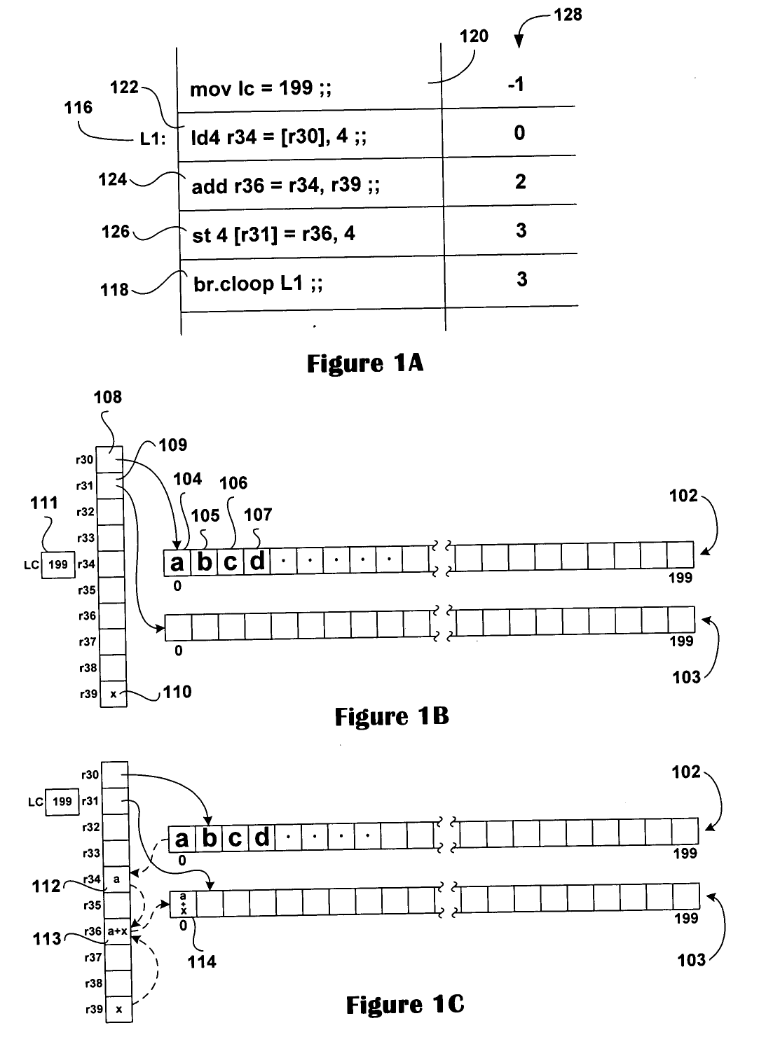

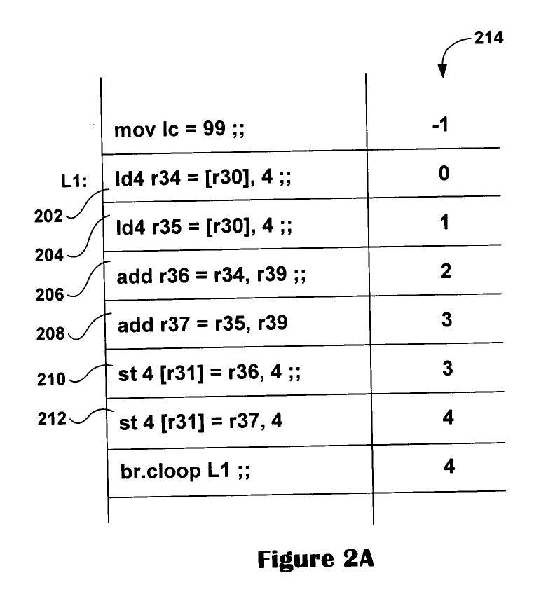

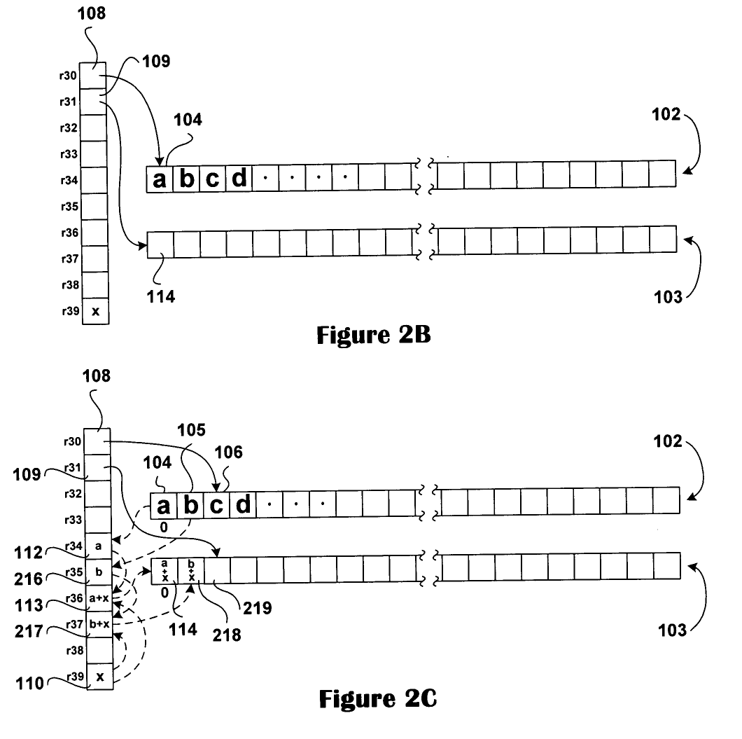

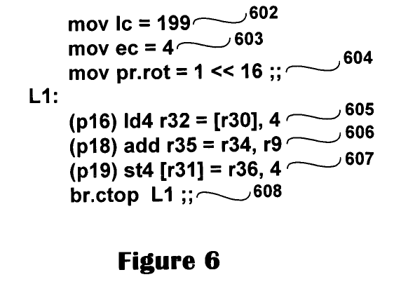

With the architectural support for software pipelining of modulo-schedule loops described above, an efficient software-pipelined version of the assembler code routine shown in FIG. 1A can now be described. FIG. 6 shows the software-pipelined version of the assembler-code routine shown in FIG. 1A. The first three instructions 602-604 constitute an initial part of a software-pipelined loop that is referred to as the “preloop phase.” During the preloop phase, the software-pipelined loop is initialized. In the current case, the loop-count register “LC” is set to the value “199,” by mov instruction 602, the epilog-count register “EC” is set to the value “4” by mov instruction 603, and the values of the rotating predicate registers are set, by mov pr.rot instruction 604, using the bit mask “0x10000000000” to indicate that only predicate register “pr16” will have the value “1,” or TRUE. The next four instructions 605-608 constitute the body of the loop. While the contents of the loop count register “LC” is greater than zero, and predicate registers “p16,” “p17,” “p18,” and “p19” are not yet all set TRUE by predicate-register rotation, execution of the loop body occurs in the prolog phase of software-pipeline-loop execution. Once predicate registers “p16,” “p17,” “p18,” and “p19” are all set to TRUE, by predicate-register rotation, execution of the loop body occurs in the kernel phase of software-pipeline-loop execution. When the value of the loop-count register “LC” reaches zero, the next branch taken by the “br.ctop” instruction 608, starts what is referred to as the “epilog phase” of execution. The epilog phase of execution continues until the value of the epilog-count register “EC” falls to one.

In the assembler code in FIG. 6, perceived general register “r32” is loaded with the next value from the first array (102 in FIG. 1B) by ld4 instruction 605. The add instruction 606 adds the contents of register “r9” to the contents of perceived general register “r34,” and places the sum into register “r35.” The st4 instruction 607 stores the contents of perceived general register “r36” into the element of the second array (103 in FIG. 1B) referenced by the contents of register “r31,” with register “r31” post incremented. Note that execution of each of the loop-body instructions 605-607 is controlled by a different predicate register. Execution of the ld4 instruction 605 is controlled by predicate register “p16.” Execution of the add instruction 606 is controlled by predicate register “p18.” Execution of the st4 instruction 607 is controlled by predicate register “p19.”

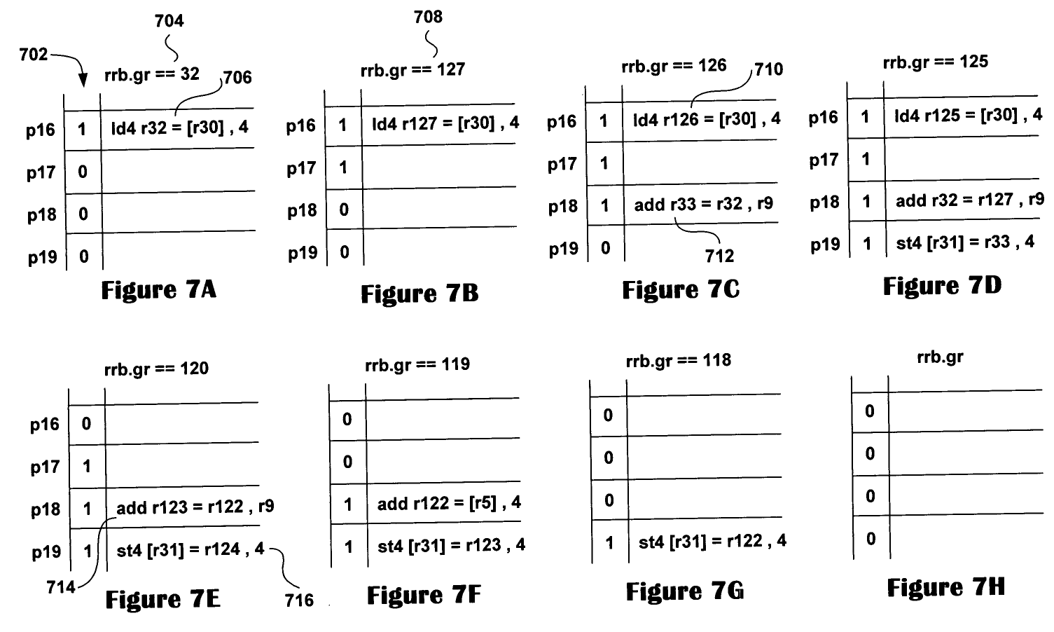

Operation of the software-pipelined version of the assembler-code loop, shown in FIG. 6, is illustrated in FIGS. 7A-7H. When the ld4 instruction (605 in FIG. 6) is executed the first time through the loop, the general register rotating-base field is assumed to index the first general rotating register “r32.” The contents of the first rotating predicate register “p16” is “1,” or TRUE, as set by mov instruction 604. In FIG. 7A, as with the remaining FIGS. 7B-H of the example, the contents of the perceived predicate registers “p16”-“p19” are shown in a left column 702, the contents of the general rotating register-base field “rrb.gr” is shown in a header 704, and the instructions that execute are explicitly shown 706 in terms of the actual general register used by the instruction, rather than the perceived general register designations which depend on the current value of the field “rrb.gr.”

The first iteration of the loop, illustrated in FIG. 7A, begins the prolog phase of the loop, in which loop predicates are turned on, one-by-one. During the first iteration of the loop, the general rotating register-base field indexes the first general rotating register, “r32,” and thus the ld4 instruction (605 in FIG. 6) loads register “r32,” which is the actual register perceived as being register “r32.” In the first iteration of the loop, only the perceived predicate register “p16” associated with the load instruction has the value “1,” or TRUE. Therefore, only the ld4 instruction (605 in FIG. 6) executes during the first iteration of the loop. FIG. 7B illustrates the second iteration of the loop shown in FIG. 6. Note, as shown in FIG. 5, that when the br.ctop instruction (608 in FIG. 6) directs control back to the top of the loop (605 in FIG. 6), the value “1,” or TRUE, is placed into predicate register “p63” and the predicate register rotating-base field is then decremented. Thus, in the second iteration of the loop, as shown in FIG. 7B, the value stored in perceived predicate register “p17” is now “1,” or TRUE, and the value stored in perceived predicate register “p16” is also “1,” or TRUE. The value of perceived predicate register “p17” has changed from “0” to “1” because of predicate register rotation. Perceived register “p17” is actual predicate register “p16.” Similarly, the value “1” inserted into perceived predicate register “p63” by the br.ctop instruction in step 506 is now stored in perceived predicate register “p16” due to the predicate register rotation carried out by decrementing the predicate register rotating-base field in FIG. 508. Note also that the general register rotating-base field has been decremented, and, in the second iteration loop, has the value “127” 708. In FIG. 7B, the ld4 instruction is shown using actual, rather than perceived, general registers. Thus, the ld4 instruction loads the next element from the first array (102 in FIG. 1B) into register “r127.” Thus, because of general register rotation, rather than needing to explicitly use a different register to hold the next value extracted from the first array, the ld4 instruction (605 in FIG. 6) expressed in terms of perceived general registers ends up, in each successive iteration, loading the next element from the first array into the next lowest rotating general register.

FIG. 7C illustrates the third iteration of the assembler-code loop shown in FIG. 6. In FIG. 7C, because of predicate and general register rotation, the values of perceived predicate registers “p16”-“p18” are now all “1,” or TRUE, and the actual registers that are targets of the ld4 and add instructions 710 and 712 are two general registers lower than the perceived general registers expressed in the ld4 and add instructions (605 and 606 in FIG. 6) in the written assembler code. The third iteration of the loop is the first iteration in which perceived predicate register “p18” is TRUE, and in which the add instruction (606 in FIG. 6) is therefore executed. FIG. 7D shows the fourth iteration of the loop. In the fourth iteration of the loop, all four perceived predicate registers “p16”-“p19” have the value “1,” or TRUE, due to predicate register rotation. This is the beginning of the kernel phase of the loop. Iteration four is the first iteration in which the st4 instruction (607 in FIG. 6) is executed. Due to general register rotation, the perceived general register “r36” that appears explicitly in the written instruction (607 in FIG. 6) is now actual register “r33.” The fourth iteration of the loop, shown in FIG. 7D, is the first iteration of the loop in which the software pipeline is fully filled, and all three instructions are executing during each iteration of the loop.

The kernel of the phase of the loop continues until the loop-control register “LC” is finally decremented to zero by the “br.ctop” instruction (608 in FIG. 6). This occurs when all 200 elements of the first array (102 in FIG. 1B) have been moved to the second array (103 in FIG. 3). At this point, the epilog phase of loop execution ensues. Note that, in the epilog phase, the value “0” is placed into perceived predicate register “p63” in step 516 of the “br.ctop” flow control diagram in FIG. 5. This leads to the perceived value of predicate register “p16” being “0” in the subsequent iteration. FIG. 7E illustrates the first iteration of the epilog phase of the loop execution. Perceived predicate register “p16” now has the value “0,” placed into perceived predicate register “p63” by the br.ctop instruction, in step 516 of the flow control diagram of FIG. 5, during the preceding iteration of the loop. Because perceived predicate register “p16” now has the value “0,” or FALSE, the ld4 instruction (605 in FIG. 6) is not executed. The add instruction 714 accesses the value stored in actual register “r122” two iterations of the loop prior to the current iteration. Similarly, the st4 instruction 716 accesses the value in actual register “r124” placed there by the add instruction of the previous iteration.

FIG. 7F shows the second iteration of the loop during the epilog phase. Note that, due to predicate register rotation, predicate registers “p16” and “p18” both now have the value “0.” FIG. 7G shows the third iteration of the epilog phase of execution of the software-pipelined loop shown in FIG. 6. This is the last iteration of the software-pipelined loop. Because of predicate register rotation, only predicate register “p19” now has the value “1,” and therefore only the st4 instruction (607 in FIG. 6) executes. When the br.ctop instruction (608 in FIG. 6) follows execution of the store instruction in the third iteration of the software-pipelined loop of the epilog phase, the value in the epilog-count register “EC” is “1,” and the br.ctop instruction therefore finishes execution without directing control back to the first instruction at the top of the software-pipelined loop.

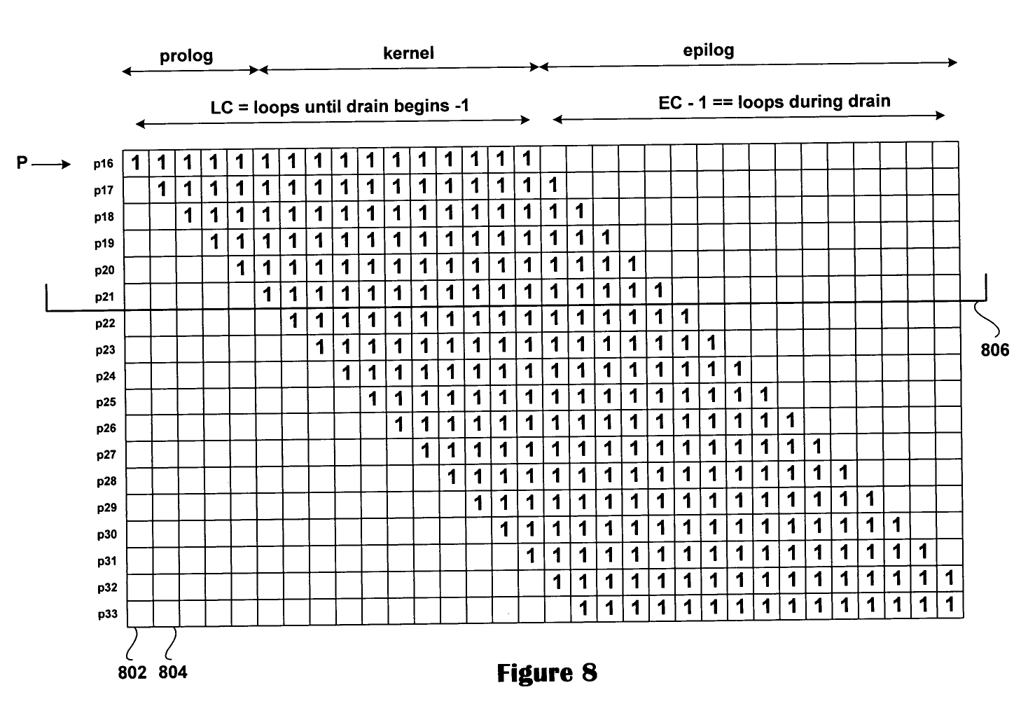

FIG. 8 is a high-level illustration of the perceived values of predicate registers during execution of a software-pipelined loop. Each column, such as column 802 in FIG. 8, represents the value of the perceived predicate registers during a specific iteration of a software-pipelined loop. Note that predicate register “p16” is the only predicate register with a value of “1” during the first iteration of a software-pipelined loop, set by an instruction such as instruction 604 in FIG. 6. As shown in FIG. 8, with each successive iteration of the software-pipelined loop during the kernel phase of execution, one more perceived predicate register is set to the value “1” due to step 506 in FIG. 5 of the br.ctop instruction and due to predicate register rotation, in step 508 of FIG. 5. Thus, in the second iteration of the software-pipelined loop, both perceived predicate registers “p16” and “17” have the values “1” 804. Note that, in FIG. 8, a cell not marked with the value “1” has the value “0.” As noted above, the value initially stored in the “LC” register controls the number of iterations of the software-pipelined loop. Thus, in the example shown in FIG. 8, the 5 iterations in the prolog phase and the 11 iterations of the kernel phase are specified by loading the value “15” into the loop-count register “LC” in the pre-loop phase of the software-pipelined loop. In other words, the value stored in LC equals the number of time the loop iterates minus one. The number of iterations of the epilog phase of the software-pipelined loop, during which the software pipeline drains, is controlled by the value placed into the epilog-count register “EC” in a prolog phase of software-pipelined loop execution. One less than the initial value of the “EC” register iterations are carried out during the epilog phase of software-pipelined loop execution. In the example shown in FIG. 8, 16 epilog-phase loop iterations occur, indicating that the value “17” is initially stored into the epilog-count register “EC” in the prolog phase. Of course, in any particular loop, not all of the rotating predicate registers may be used. If, for example, in the example in FIG. 8, only predicate registers “p16” through “p21 ” are explicitly used in the instructions, as indicated by the horizontal bracket 806, then the pattern of predicate register values during kernel and epilog phases of execution has the form of a trapezoid containing the values “1.” The trailing corner of the trapezoid may be truncated by shortening the epilog phase.

Note that, in the architecturally intended, and modern-processor-vendor promulgated, software pipelining technique discussed above with reference to FIGS. 3-8, perceived predicate register “p16” always controls the epilog phase of software-pipelined loop execution. Only this perceived predicate register has the value “1,” or TRUE, during the first iteration of the software-pipelined loop, and perceived predicate register “p16” is the first rotating predicate register zeroed during the epilog phase of software-pipelined loop execution. Use of predicate register “p16” as the control-predicate register places rather heavy constraints on the types of possible encodings of software-pipelined loops. Use of perceived predicate register “p16” as the single software-pipelined loop-control-predicate register also constrains a software-pipelined loop to a single stream, or thread, of execution, with the software-pipeline filling during those prolog iterations before all perceived predicate registers explicitly used within the software-pipelined loop acquire the value “1,” and the software-pipeline draining once perceived control-predicate register “p16” is set to “0” in the first iteration of the epilog phase.

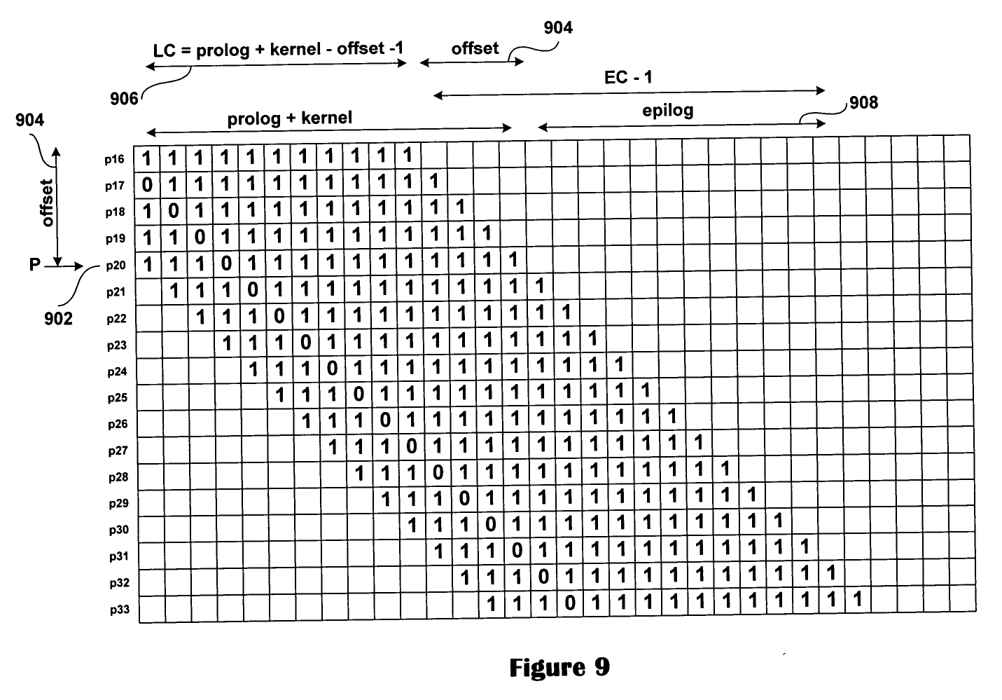

One embodiment of the present invention relaxes the constraint of the use of perceived predicate register “p16” as the control-predicate register for a software-pipelined loop. FIG. 9 illustrates the prolog, kernel, and epilog phases of software-pipelined loop execution under the described embodiment of the present invention using the illustration conventions of FIG. 8. As shown in FIG. 9, any arbitrary rotating predicate register may be selected as the control register for the software-pipelined loop. In the example shown in FIG. 9, perceived predicate register “p20” 902 is selected as the control-predicate register. The selected control-predicate register can be viewed as being offset 904 from the highest static predicate register “p15” by some number of predicate registers within an ordered sequence of predicate registers. In the example shown in FIG. 9, the offset has the integer value “5.” The predicate registers preceding the selected control-predicate register, in the example shown in FIG. 9 predicate registers “p16”-“p19,” can be set to either “1” or “0,” depending on the needs of the programmer. In the technique that represents one embodiment of the present invention, the offset 904 needs to be subtracted from the initial value of the loop-count register “LC” and added to the initial value of the epilog-count register “EC.” In other words, whereas in the traditional case, illustrated in FIG. 8, the initial value of the loop-count register “LC” is the number of loop iterations minus one, under the technique of one embodiment of the present invention, illustrated in FIG. 9, the initial value of the loop-count register “LC” is set equal to the number of loop iterations minus the offset 904 minus one, and the initial value of the epilog-count register “EC” plus offset 904 specifies the number of iterations of the epilog phase. Thus, under the technique that represents one embodiment of the present invention, rather than using predicate register “p16” as the control-predicate register, the control-predicate register may be shifted upward to an arbitrary predicate register, with the initial values of the loop-count register “LC” decreased by the offset amount, and the initial value of the epilog-count register “EC” increased by the offset amount, to create a software-pipelined loop controlled by the selected predicate register.

The following simple counted loop example shows a simple, counted loop traditionally coded to use predicate register “p16” as the single control register for the counted loop. First, the assembly code for the loop is provided, below, followed by a table that shows the values of predicate registers during loop iterations, or cycles, and indications of the functional units that execute instructions in each cycle:

mov lc=199//LC=loop count−1

mov ec=4//EC=epilog stages+1

mov pr.rot=1<<16;;//PR16=1, rest=0

L1:

(p16)ld4 r32=[r30],4//Cycle 0

(p18)add r35=r34,r9//Cycle 0

(p19)st4 [r31]=r36,4//Cycle 0

br.ctop L1;;//Cycle 0

| | |
|---|---|
| Port/Instructions | State before br.ctop |

| Cycle | M | I | M | B | p16 | p17 | p18 | p19 | p20 | LC | EC |
|---|---|---|---|---|---|---|---|---|---|---|---|
| 0 | Id4 | | | br.ctop | 1 | 0 | 0 | 0 | 0 | 199 | 4 |
| 1 | Id4 | | | br.ctop | 1 | 1 | 0 | 0 | 0 | 198 | 4 |
| 2 | Id4 | add | | br.ctop | 1 | 1 | 1 | 0 | 0 | 197 | 4 |
| 3 | Id4 | add | st4 | br.ctop | 1 | 1 | 1 | 1 | 0 | 196 | 4 |
| . | . | . | . | . | . | . | . | . | . | . | . |
| . | . | . | . | . | . | . | . | . | . | . | . |
| . | . | . | . | . | . | . | . | . | . | . | . |
| 100 | Id4 | add | st4 | br.ctop | 1 | 1 | 1 | 1 | 1 | 99 | 4 |
| . | . | . | . | . | . | . | . | . | . | . | . |
| . | . | . | . | . | . | . | . | . | . | . | . |
| . | . | . | . | . | . | . | . | . | . | . | . |
| 198 | Id4 | add | st4 | br.ctop | 1 | 1 | 1 | 1 | 1 | 0 | 4 |
| 199 | Id4 | add | st4 | br.ctop | 1 | 1 | 1 | 1 | 1 | 0 | 4 |
| 200 | | add | st4 | br.ctop | 0 | 1 | 1 | 1 | 1 | 0 | 3 |
| 201 | | add | st4 | br.ctop | 0 | 0 | 1 | 1 | 1 | 0 | 2 |
| 202 | | | st4 | br.ctop | 0 | 0 | 0 | 1 | 1 | 0 | 1 |
| . . . | | | | | 0 | 0 | 0 | 0 | 0 | 0 | 0 |

In the next example, the loop count and epilog count initial values are shifted, as discussed above with respect to FIG. 9, so that predicate register “p17” becomes the control register for the counted loop:

mov lc=198//LC=loop count−2

mov ec=5//EC=epilog stages+2

mov pr.rot=3<<16;;//PR16 and PR17=1, rest=0

L1:

(p17)ld4 r32=[r30],4//Cycle 0

(p19)add r35=r34,r9//Cycle 0

(p20)st4 [r31]=r36,4//Cycle 0

br.ctop L1;;//Cycle 0

| | |
|---|---|
| Port/Instructions | State before br.ctop |

| Cycle | M | I | M | B | p16 | p17 | p18 | p19 | p20 | LC | EC |
|---|---|---|---|---|---|---|---|---|---|---|---|
| 0 | Id4 | | | br.ctop | 1 | 1 | 0 | 0 | 0 | 198 | 5 |
| 1 | Id4 | | | br.ctop | 1 | 1 | 1 | 0 | 0 | 197 | 5 |
| 2 | Id4 | add | | br.ctop | 1 | 1 | 1 | 1 | 1 | 196 | 5 |
| 3 | Id4 | add | st4 | br.ctop | 1 | 1 | 1 | 1 | 1 | 195 | 5 |
| . | . | . | . | . | . | . | . | . | . | . | . |
| . | . | . | . | . | . | . | . | . | . | . | . |
| . | . | . | . | . | . | . | . | . | . | . | . |
| 100 | Id4 | add | st4 | br.ctop | 1 | 1 | 1 | 1 | 1 | 98 | 5 |
| . | . | . | . | . | . | . | . | . | . | . | . |
| . | . | . | . | . | . | . | . | . | . | . | . |
| . | . | . | . | . | . | . | . | . | . | . | . |
| 198 | Id4 | add | st4 | br.ctop | 1 | 1 | 1 | 1 | 1 | 0 | 5 |
| 199 | Id4 | add | st4 | br.ctop | 0 | 1 | 1 | 1 | 1 | 0 | 4 |
| 200 | | add | st4 | br.ctop | 0 | 0 | 1 | 1 | 1 | 0 | 3 |
| 201 | | add | st4 | br.ctop | 0 | 0 | 0 | 1 | 1 | 0 | 2 |
| 202 | | | st4 | br.ctop | 0 | 0 | 0 | 0 | 1 | 0 | 1 |
| . . . | | | | | 0 | 0 | 0 | 0 | 0 | 0 | 0 |

Finally, in a third example, below, the loop count and epilog count are additionally shifted, so that predicate register “p19” becomes the controlling register:

mov lc=196//LC=loop count−4

mov ec=7//EC=epilog stages+4

mov pr.rot=0xf<<16;;//PR16, PR17, PR18 and PR19=1, rest=0

L1:

(p19)ld4 r32=[r30],4//Cycle 0

(p21)add r35=r34,r9//Cycle 0

(p22)st4 [r31]=r36,4//Cycle 0

br.ctop L1;;//Cycle 0

| | Port/Instructions | | | | State before br.ctop | | | | | | | | |
|---|---|---|---|---|---|---|---|---|---|---|---|---|---|
| Cycle | M | I | M | B | p16 | p17 | p18 | p19 | p20 | p21 | p22 | LC | EC |
| 0 | Id4 | | | br.ctop | 1 | 1 | 1 | 1 | 0 | 0 | 0 | 196 | 7 |
| 1 | Id4 | | | br.ctop | 1 | 1 | 1 | 1 | 1 | 0 | 0 | 195 | 7 |
| 2 | Id4 | add | | br.ctop | 1 | 1 | 1 | 1 | 1 | 1 | 0 | 194 | 7 |
| 3 | Id4 | add | st4 | br.ctop | 1 | 1 | 1 | 1 | 1 | 1 | 1 | 193 | 7 |
| . | . | . | . | . | . | . | . | . | . | . | . | . | . |
| . | . | . | . | . | . | . | . | . | . | . | . | . | . |
| . | . | . | . | . | . | . | . | . | . | . | . | . | . |
| 100 | Id4 | add | st4 | br.ctop | 1 | 1 | 1 | 1 | 1 | 1 | 1 | 96 | 7 |
| . | . | . | . | . | . | . | . | . | . | . | . | . | . |
| . | . | . | . | . | . | . | . | . | . | . | . | . | . |
| . | . | . | . | . | . | . | . | . | . | . | . | . | . |
| 196 | Id4 | add | st4 | br.ctop | 1 | 1 | 1 | 1 | 1 | 1 | 1 | 0 | 7 |
| 197 | Id4 | add | st4 | br.ctop | 0 | 1 | 1 | 1 | 1 | 1 | 1 | 0 | 6 |
| 198 | Id4 | add | st4 | br.ctop | 0 | 0 | 1 | 1 | 1 | 1 | 1 | 0 | 5 |
| 199 | Id4 | add | st4 | br.ctop | 0 | 0 | 0 | 1 | 1 | 1 | 1 | 0 | 4 |
| 200 | | add | st4 | br.ctop | 0 | 0 | 0 | 0 | 1 | 1 | 1 | 0 | 3 |
| 201 | | add | st4 | br.ctop | 0 | 0 | 0 | 0 | 0 | 1 | 1 | 0 | 2 |
| 202 | | | st4 | br.ctop | 0 | 0 | 0 | 0 | 0 | 0 | 1 | 0 | 1 |
| . . . | | | | | 0 | 0 | 0 | 0 | 0 | 0 | 0 | 0 | 0 |

The method that represents one embodiment of the present invention finds use in many assembly-language coding problems in which functional processing units of a modem processor are oversubscribed during execution of a loop, introducing repeated latencies in instruction execution. For example, if there are not enough free integer functional units in the loop, to execute all the integer type instructions, the integer functional unit becomes a bottleneck for the loop execution. Often, introducing additional parallelism into a loop provides greater and more constant functional-unit loading, so that less processing cycles are wasted, increasing overall performance. For example, the following counted loop processes 4-byte integers, accessed from memory using a load instruction, via deposit and sign-extension instructions, depositing 4-byte quantities back to memory. As shown in comments in the assembly code, below, the counted loop needs two processing cycles for each loop cycle:

```
//First Loop single argument
loop:
{ .mfi
    (p16) Id4 r32=[r30],4
    nop.f 0x0
    (p18) dep r35=r35,r34,2,8
}
{ .mfi
    nop.m 0x1
    nop.f 0x1
    (p17) sxt4 r33=1,r33
;; // cycle 0
}
{ .mib
    (p18) st4 [r31]=r35,8
    (p17) shr r34=r33,1
    br.ctop.sptk.few loop
;; // cycle 1
}
```

Note, in the above assembly-language code, that 3-instruction bundles are demarcated by braces, and introduced by an indication of the functional processing units needs for execution of the bundle. Cycles are demarcated by double-stop “;;” notations. The same functionality can be obtained with much greater efficiency by encoding the above, single-argument counted loop as a two-argument counted loop:

```
//Second Loop two arguments
loop:
{ .mfi
    (p17) Id4 r42=[r28],4
    nop.f 0x0
    (p19) dep r36=r36,r35,2,8
}
{ .mfi
    nop.m 0x1
    nop.f 0x1
    (p18) sxt4 r34=1,r34
;; // cycle 0
}
{ .mfi
    nop.m 0x0
    nop.f 0x0
    (p19) dep r45=r45,r44,2,8
}
{ .mfi
    (p19) st4 [31]=r36,4
    nop.f 0x1
    (p18) sxt4 r43=1,r43
;; // cycle 1
}
{ .mfi
    (p16) Id4 r32=[30],4
    nop.f 0x0
    (p18) shr r44=r43,1
}
{ .mib
    (p19) st4 [29]=r45,4
    (p18) shr r35=r34,1
    br.ctop.sptk.few loop
;; // cycle 2
}
```

In the above, two-argument implementation of the counted loop, a load instruction is executed in both the first cycle and in the second cycle. By introducing two parallel streams of execution in the second implementation, using two-input arguments, one per stream, the second implementation, in each loop iteration, loads and processes 2 4-byte integers in 3 cycles, as compared to processing of a single 4-byte integer during each 2-cycle iteration of the single-argument loop. Thus, if 200 integers are processed in the single-argument counted loop, 400 processing cycles are employed, but processing of 200 integers by the two-argument loop needs only 300 processing cycles. Note that, in the second, parallel-stream counted loop, the loads are controlled by different predicate registers. This is to account for the fact that the load address is being post-incremented.

In an even length array, the first argument is loaded in the preloop phase and “p16” and “p17” are initially set to TRUE, causing an even number of values to be loaded from the input array. In an odd length array, the first value is not loaded. Instead, a “dummy” argument is loaded. In the preloop phase, “p16” and “p17” are initially set to TRUE. This causes an odd number of loads from the array. Additionally, since two stores occur, the first store writes out the result of the “dummy” argument, which is then overwritten by the result of the first array argument. It is also important to point out the arrays of one and two elements are handled differently. In the case of a single-element array, a “dummy” argument is loaded in the preloop code and only “p17” is set to TRUE. This causes only the first value of the input array to be loaded in the loop. Next, since two stores occur, the result of the “dummy” argument is written out, then overwritten by the result of the first input argument. For a two-element array, the first value of the array is loaded in the preloop phase and only “p17” is set to TRUE. This causes an even number of loads from the input array, and an even number of stores occur. The code from the above example only works for even length arrays with more than two elements. In the interest of brevity, a more complete version of the example code for handling odd length arrays and arrays with fewer than three elements is not provided.

Although the present invention has been described in terms of a particular embodiment, it is not intended that the invention be limited to this embodiment. Modifications within the spirit of the invention will be apparent to those skilled in the art. For example, a practically limitless number of different single and multi-threaded modulo-scheduled loop can be constructed according to the methods of the present invention to solve a practically limitless number of different programming problems. As discussed above, the present invention may be practiced using any of the modulo-scheduled loop instructions br.ctop, br.cexit, br.wtop, and br.wexit, supported by the Intel® Itanium architecture. As discussed above, the described embodiment of the present invention is characterized by selection of a rotating predicate register other than predicate register “p16” to control a modulo-scheduled loop, and adjustment of the initial values of the loop-count register “LC” and the epilog-count register “EC” to appropriately specify the number of iterations in the kernel phase and the epilog phase of execution, respectively. While the described embodiment employs architectural features of the Intel® Itanium architecture, a number of other modern processors may provide the modulo-scheduled-counted-loop support needed to practice the methods of the present invention.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for constructing an enhanced modulo-scheduled loop, the method comprising:
selecting a predicate-control register other than a predicate register architecturally designated as a predicate control register for control of software-pipelined modulo-scheduled loops; and
construction a loop body for the enhanced modulo-scheduled loop using the selected predicate control register to control the enhanced modulo-scheduled loop.

2. The method of claim 1 further including:
computing a predicate-control-register offset of the selected predicate-control register from the predicate control register architecturally designated as a predicate control register for control of software-pipelined modulo-scheduled loops;
initializing a loop-count register to a value equal to the computed predicate-control-register offset subtracted from the number of iterations for prolog and kernel phases of the enhanced modulo-scheduled loop; and
initializing an epilog-count register to a value equal to the computed predicate-control-register offset added to the number of iterations for an epilog phase of the enhanced modulo-scheduled loop.

3. The method of claim 2 wherein the loop-count register and the epilog-count register are initialized in a preloop phase of the enhanced modulo-scheduled loop.

4. The method of claim 2 further including initializing multiple execution streams within the enhanced modulo-scheduled loop by initializing to contain the value “1” one or more predicate registers from a range of predicate registers beginning with the predicate register architecturally designated as a predicate control register for control of software-pipelined modulo-scheduled loops and ending with the predicate register prior to the selected predicate control register in an ordered sequence of predicate registers.

5. The method of claim 2 wherein the predicate register architecturally designated as a predicate register for control of software-pipelined modulo-scheduled loops is predicate register “p16” of the Intel® Itanium register set.

6. The method of claim 1 wherein the modulo-scheduled loop employs one of the modulo-scheduled loop instructions of the Intel® Itanium instruction set including:
br.ctop;
br.cexit;
br.wtop; and
br.wexit

7. Computer instructions implementing the enhanced modulo-scheduled loop of claim 2 stored in a computer-readable medium.

8. A computer system containing one or more enhanced modulo-scheduled loops of claim 2.

9. A method for constructing an enhanced modulo-scheduled loop, the method comprising:
constructing the loop body of a modulo-scheduled loop to include two or more execution streams; and
controlling each execution stream with a distinct predicate register.

10. The method of claim 9 further including:
selecting one of the distinct predicate registers that each control an execution stream as a loop-control-predicate register.

11. The method of claim 10 further including:
computing a predicate-control-register offset of the selected loop-control-predicate register from a predicate register architecturally designated as a predicate register for control of software-pipelined modulo-scheduled loops;
initializing a loop-count register to a value equal to the computed predicate-control-register offset subtracted from the number of iterations for a kernel phase of the enhanced modulo-scheduled loop; and
initializing an epilog-count register to a value equal to the computed predicate-control-register offset added to one more than the number of iterations for an epilog phase of the enhanced modulo-scheduled loop.

12. Computer instructions implementing the enhanced modulo-scheduled loop of claim 9 stored in a computer-readable medium.

13. A computer system containing one or more enhanced modulo-scheduled loops of claim 9.
